(19) United States
(12) Patent Application Publication
(10) Pub. No.: US 2020/0160381 A1
(43) Pub. Date: May 21, 2020

(54) COGNITIVE GENERATION OF DYNAMIC PROMOTIONS ON UNPURCHASED ITEMS AND INVENTORY ASSOCIATED WITH AN UPCOMING EVENT

(71) Applicant: INTERNATIONAL BUSINESS MACHINES CORPORATION, Armonk, NY (US)

(72) Inventors: Raghuveer P. Nagar, Kota (IN); Reji Jose, Bangalore (IN)

(21) Appl. No.: 16/193,018

(22) Filed: Nov. 16, 2018

(51) Int. Cl. G06Q 30/02; G06F 17/27

(52) U.S. Cl. CPC G06Q 30/0252; G06F 17/2765; G06Q 30/0255

(57) ABSTRACT

A method, computer system, and computer program product for cognitive event-related promotion generation are provided. The embodiment may include receiving a plurality of data related to an individual's upcoming events. The embodiment may also include identifying an upcoming event based on the plurality of received data. The embodiment may further include extracting event parameters from the received data related to the upcoming events utilizing natural language processing technologies. The embodiment may also include determining purchasable products associated with the identified upcoming events and the extracted event parameters. The embodiment may further include collecting a plurality of purchase history data associated with the individual. The embodiment may also include determining a product within the determined purchasable products was purchased in the past by the individual based on the determined plurality of purchase history data associated with the individual.

### BACKGROUND

The present invention relates, generally, to the field of computing, and more particularly to product recommendation systems.

A product recommendation system is a filtering system that predicts an item or service that a user is likely to purchase in the near future. A product recommendation system is often implemented with e-commerce websites to recommend a product or a service to a user. When companies want to target advertisements at a particular customer, they usually cross-reference data and historic purchases to determine what products or services would interest similar customers. Untargeted recommendations or advertisements may be ineffective as they are static in nature as the same information or content is displayed to viewers at a time irrespective of their preferences or interests. Typically, there are three types of filtering systems: collaborative filtering, content-based filtering, and hybrid filtering. A collaborative filtering method relates to collecting and analyzing information on user behaviors, activities or preferences to predict what a user is likely to purchase. It is generally based on the assumption that a user will purchase products similar to what the user purchased in the past. A content-based filtering method relates to comparing the keywords that are used to describe a product or service to the keywords used in a user profile or manually generated preferences. A hybrid filtering method relates to implementing the other two filtering methods first and combining them together afterward to provide more accurate and effective recommendations so that a user may avoid a situation where the user is unaware of existing products or services that are already owned and thereby making unnecessary purchases.

### SUMMARY

According to one embodiment, a method, computer system, and computer program product for cognitive event-related promotion generation are provided. The embodiment may include receiving a plurality of data related to an individual's upcoming events. The embodiment may also include identifying an upcoming event based on the plurality of received data. The embodiment may further include extracting event parameters from the received data related to the upcoming events utilizing natural language processing technologies. The embodiment may also include determining purchasable products associated with the identified upcoming events and the extracted event parameters. The embodiment may further include collecting a plurality of purchase history data associated with the individual. The embodiment may also include determining a product within the determined purchasable products was purchased in the past by the individual based on the determined plurality of purchase history data associated with the individual.

### BRIEF DESCRIPTION OF THE SEVERAL VIEWS OF THE DRAWINGS

These and other objects, features, and advantages of the present invention will become apparent from the following detailed description of illustrative embodiments thereof, which is to be read in connection with the accompanying drawings. The various features of the drawings are not to scale as the illustrations are for clarity in facilitating one skilled in the art in understanding the invention in conjunction with the detailed description. In the drawings:

FIG. 1 illustrates an exemplary networked computer environment according to at least one embodiment;

FIG. 2 is an operational flowchart illustrating a cognitive event-related promotion generation process according to at least one embodiment;

FIG. 3 is a functional block diagram of a cognitive event-related promotion generation platform according to at least one embodiment;

FIG. 4 is a block diagram of internal and external components of computers and servers depicted in FIG. 1 according to at least one embodiment;

FIG. 5 depicts a cloud computing environment according to an embodiment of the present invention; and

FIG. 6 depicts abstraction model layers according to an embodiment of the present invention.

### DETAILED DESCRIPTION

Detailed embodiments of the claimed structures and methods are disclosed herein; however, it can be understood that the disclosed embodiments are merely illustrative of the claimed structures and methods that may be embodied in various forms. This invention may, however, be embodied in many different forms and should not be construed as limited to the exemplary embodiments set forth herein. In the description, details of well-known features and techniques may be omitted to avoid unnecessarily obscuring the presented embodiments.

Embodiments of the present invention relate to the field of computing, and more particularly to product recommendation systems. The following described exemplary embodiments provide a system, method, and program product to collect and analyze data associated with upcoming events for a user, determine purchasable products for the upcoming events and generate promotions targeted to the user based on the determined purchasable products or historic purchases. Therefore, the present embodiment has the capacity to improve the technical field of product recommendation systems by generating and providing effective promotions at a more appropriate time before a certain event start date and time.

As previously described, a product recommendation system is a filtering system that predicts an item or service that a user is likely to purchase in the near future. A product recommendation system is often implemented with e-commerce websites to recommend a product or a service to a user. When companies want to target advertisements at a particular customer, they usually cross-reference data and historic purchases to determine what products or services would interest similar customers. Typically, there are three types of filtering systems: collaborative filtering, content-based filtering, and hybrid filtering. A collaborative filtering method relates to collecting and analyzing information on user behaviors, activities or preferences to predict what a user is likely to purchase. It is generally based on the assumption that a user will purchase products similar to what the user purchased in the past. A content-based filtering method relates to comparing the keywords that are used to describe a product or service to the keywords used in a user profile or manually generated preferences. A hybrid filtering method relates to implementing the other two filtering methods first and combining them together afterward to provide more accurate and effective recommendations so that a user may avoid a situation where the user is unaware of existing products or services that are already owned and thereby making unnecessary purchases.

Untargeted recommendations or advertisements may be ineffective as they are static in nature as the same information or content are displayed to viewers at a time irrespective of their preferences or interests. Also, many customers tend to forget what to purchase or how much they need to purchase without considering the remaining quantities of the same products at home. Making additional trips to purchase the products that are still available at home would be a waste of time and money. Furthermore, when certain events are upcoming, and a customer needs to purchase some item in advance, the customer is often unsure as to what, how much or how many of a certain product the customer needs to purchase in preparation for an upcoming event. As such, it may be advantageous to, among other things, implement a system capable of detecting upcoming events and determining purchasable items associated with the upcoming event based on the analysis of the customer's purchase history so that the customer may not only avoid purchasing unneeded products or services but also may purchase needed products or services. It may also be advantageous to implement such a system so that distributors, vendors or service providers may promote or advertise their products or services more effectively by targeting the products at specific groups of people with specific interests.

According to one embodiment, a cognitive event-related promotion generation program may collect data related to a customer's upcoming events and determine purchasable items or services associated with the upcoming events. In at least one embodiment, the cognitive event-related promotion generation program may collect and parse the customer's historic purchase data and determine whether the purchasable items were purchased in the past or the purchased items are already expired, obsolete or unconsumable based on data related to consumable lifespans of certain items from multiple manufacture databases so that it may generate appropriate promotions on the purchasable products or services that the customer is likely to purchase.

The present invention may be a system, a method, and/or a computer program product at any possible technical detail level of integration. The computer program product may include the computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer-readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or another device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The following described exemplary embodiments provide a system, method, and program product for determining purchasable products or services associated with upcoming events of a customer that are detected from both structured and unstructured data and generating targeted promotions on such products or services.

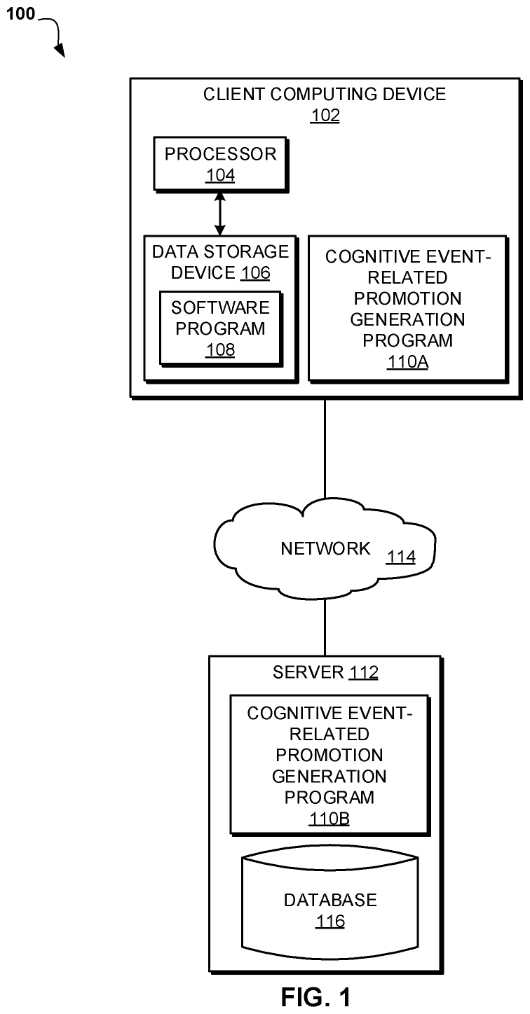

Referring to FIG. 1, an exemplary networked computer environment 100 is depicted, according to at least one embodiment. The networked computer environment 100 may include client computing device 102 and a server 112 interconnected via a communication network 114. According to at least one implementation, the networked computer environment 100 may include a plurality of client computing devices 102 and servers 112 of which only one of each is shown for illustrative brevity.

The communication network 114 may include various types of communication networks, such as a wide area network (WAN), local area network (LAN), a telecommunication network, a wireless network, a public switched network and/or a satellite network. The communication network 114 may include connections, such as wire, wireless communication links, or fiber optic cables. It may be appreciated that FIG. 1 provides only an illustration of one implementation and does not imply any limitations with regard to the environments in which different embodiments may be implemented. Many modifications to the depicted environments may be made based on design and implementation requirements.

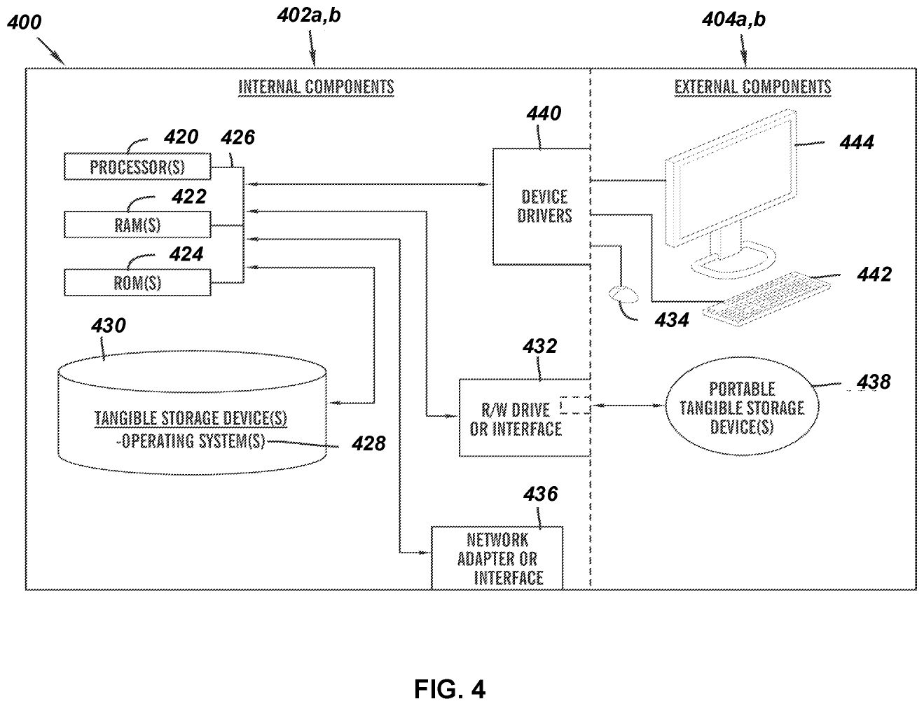

Client computing device 102 may include a processor 104 and a data storage device 106 that is enabled to host and run a software program 108 and a cognitive event-related promotion generation program 110A and communicate with the server 112 via the communication network 114, in accordance with one embodiment of the invention. Client computing device 102 may be, for example, a mobile device, a telephone, a personal digital assistant, a netbook, a laptop computer, a tablet computer, a desktop computer, or any type of computing device capable of running a program and accessing a network. As will be discussed with reference to FIG. 4, the client computing device 102 may include internal components 402a and external components 404a, respectively.

The server computer 112 may be a laptop computer, netbook computer, personal computer (PC), a desktop computer, or any programmable electronic device or any network of programmable electronic devices capable of hosting and running a cognitive event-related promotion generation program 110B and a database 116 and communicating with the client computing device 102 via the communication network 114, in accordance with embodiments of the invention. As will be discussed with reference to FIG. 4, the server computer 112 may include internal components 402b and external components 404b, respectively. The server 112 may also operate in a cloud computing service model, such as Software as a Service (SaaS), Platform as a Service (PaaS), or Infrastructure as a Service (IaaS). The server 112 may also be located in a cloud computing deployment model, such as a private cloud, community cloud, public cloud, or hybrid cloud.

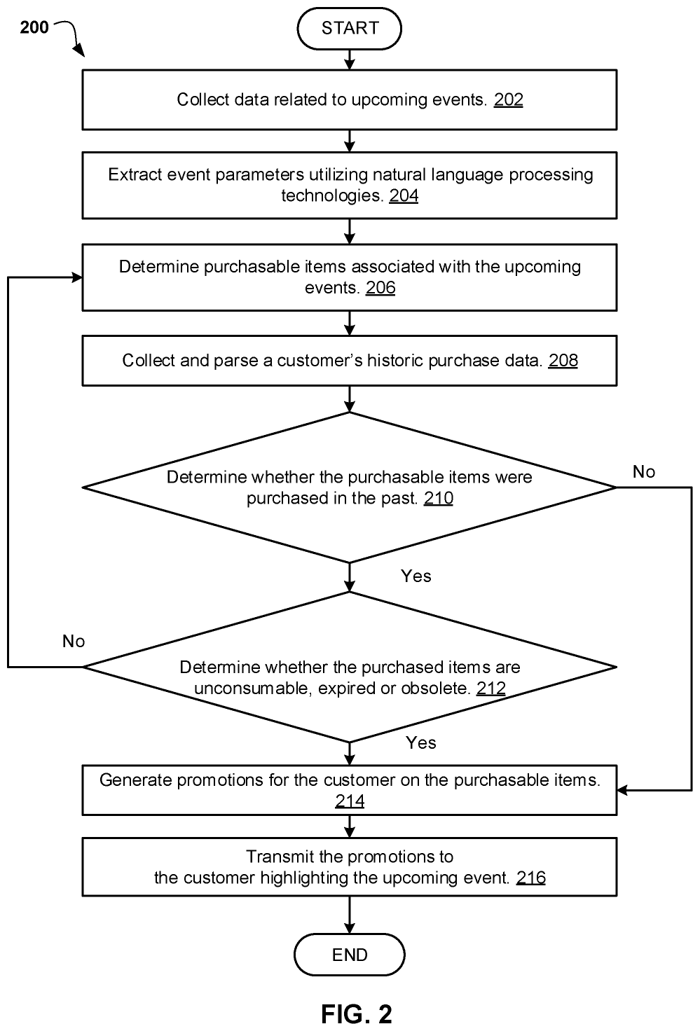

According to the present embodiment, the cognitive event-related promotion generation program 110A, 110B may be a program capable of collecting data related to a customer's upcoming events and extracting events parameters utilizing natural language processing technologies. The cognitive event-related promotion generation program 110A, 110B may also analyze the customer's historic purchase data to determine purchasable products or services and generate targeted promotions on such products or services. The cognitive event-related promotion generation process is explained in further detail below with respect to FIG. 2.

FIG. 2 is an operational flowchart illustrating a cognitive event-related promotion generation program process 200 according to at least one embodiment. At 202, the cognitive event-related promotion generation program 110A, 110B collects data related to upcoming events. According to one embodiment, the cognitive event-related promotion generation program 110A, 110B may access a customer's calendar application, emails, short message services (SMS) and blog posts to collect a plurality of data related to a customer's upcoming events. Such upcoming events may include a vacation, an anniversary, holidays, birthdays, a graduation ceremony, an official meeting, etc. In at least one other embodiment, the cognitive event-related promotion generation program 110A, 110B may collect data related to upcoming events based on a customer ID issued by an e-commerce website. For example, when a customer of an e-commerce website opens an application distributed by the website, the server of the e-commerce website will receive the customer identifiers as an input, and the cognitive event-related promotion generation program 110A, 110B may fetch the customer's upcoming event data which may be either structured data, such as calendar data or unstructured data, such as SMS and emails.

At 204, the cognitive event-related promotion generation program 110A, 110B extracts event parameters utilizing natural language processing technologies. According to one embodiment, the cognitive event-related promotion generation program 110A, 110B may process the collected unstructured data to extract certain event parameters, such as a start date, a start time, an end date, an end time, venues, participants, durations, themes, etc. For example, the cognitive event-related promotion generation program 110A, 110B may utilize natural language processing technologies, such as morphological, grammatical, syntactic and semantic analyses of language to extract different types of key elements (e.g. topics, locations, people, companies, dates, etc.), and generate the metadata that can be used to tag and categorize content in sentences such as “Congratulations on your booking!”, “I will be out of the office until the end of November.”, “Invitation to a celebration party at XYZ manor”, etc. In this example, the cognitive event-related promotion generation program 110A, 110B may extract data related to a theme of a gathering, the duration of an event and a venue where the event will be held. According to one other embodiment, the cognitive event-related promotion generation program 110A, 110B may save event parameters already extracted from structured data at the outset in step 202 in a plurality of servers or databases simultaneously or almost simultaneously.

At 206, the cognitive event-related promotion generation program 110A, 110B determines purchasable items associated with the upcoming events. According to one embodiment, the cognitive event-related promotion generation program 110A, 110B may determine what a customer might need to purchase in anticipation of an upcoming event. For example, if a customer has a two-week vacation plan at Miami Beach starting next Sunday, the cognitive event-related promotion generation program 110A, 110B may determine that the customer may need shorts to wear at the beach, a DSLR camera and camera lenses, hats, and sunglasses. The associated inventories may also be searched for additional quantities of the same products in case the customer needs more shorts or cameras for the planned vacation trip. Further, the cognitive event-related promotion generation program 110A, 110B may configure a time period to determine in the near future, or when a customer needs particular products or services in anticipation of a certain upcoming event. The cognitive event-related promotion generation program 110A, 110B may allow a customer to manually configure an appropriate timeline or timing for receiving promotions on purchasable items. For example, a customer may manually pre-configure the system to receive a promotion or notification from the cognitive event-related promotion generation program 110A, 110B on products, such as jewelry, wine or flower bouquets for an upcoming event (e.g. wedding anniversary) 10 or 15 days before the actual anniversary date.

At 208, the cognitive event-related promotion generation program 110A, 110B collects and parses a customer's historic purchase date. According to one embodiment, the cognitive event-related promotion generation program 110A, 110B may interact with a plurality of external databases (e.g. a website user order history) simultaneously or almost simultaneously to retrieve data related to a customer's purchase histories. The cognitive event-related promotion generation program 110A, 110B may then parse the collected data to determine whether the determined purchasable items were purchased by the same customer in the past. In one other embodiment, the cognitive event-related promotion generation program 110A, 110B may collect historic purchase data from social media sites or old emails. For example, the cognitive event-related promotion generation program 110A, 110B may determine that a customer purchased the same or similar product in the past based on a picture of an anniversary gift (e.g. wine, jewelry, flower bouquets) posted on a social media site a year ago.

At 210, the cognitive event-related promotion generation program 110A, 110B determines whether the purchasable items were purchased in the past through a comparison of the purchasable items and the retrieved data related to a customer's purchase histories in step 208. According to one embodiment, if the cognitive event-related promotion generation program 110A, 110B determines that the purchasable items associated with an upcoming event which were identified in step 206 were purchased by the same customer in the past (step 210, “Yes” branch), then the cognitive event-related promotion generation program 110A, 110B may continue to step 212 to further determine whether the purchased items or respective inventories are old. If the cognitive event-related promotion generation program 110A, 110B determines that the purchasable items were not purchased in the past (step 210, “No” branch), then the cognitive event-related promotion generation program 110A, 110B may continue to step 214 to generate promotions for the same customer on the identified purchasable items and inventories.

At 212, the cognitive event-related promotion generation program 110A, 110B determines whether the purchased items are unconsumable, expired or obsolete. According to one other embodiment, the cognitive event-related promotion generation program 110A, 110B may collect data related to consumable lifespans of certain items from a plurality of manufacture databases and determine whether certain products are still consumable or useable. In at least one other embodiment, the cognitive event-related promotion generation program 110A, 110B may configure a threshold value of duration after which a product may be considered unconsumable, expired or obsolete and determine whether a purchased date associated with the product exceeds the preconfigured threshold value based on the purchase pattern determined from the customer's purchase history or data manually configured by a customer in advance or based on the definition of the products in a catalog. If the cognitive event-related promotion generation program 110A, 110B may determine that the purchased items are expired or unconsumable for the upcoming events so that a customer may need to repurchase the same products (step 212, “Yes” branch), then the cognitive event-related promotion generation program 110A, 110B may continue to step 214 to generate promotions on those items and the respective inventories. If the cognitive event-related promotion generation program 110A, 110B determines that the purchased items are not expired and still consumable or needed, and thus that the same items do not need to be repurchased (step 212, “No” branch), then the cognitive event-related promotion generation program 110A, 110B may return to step 206 to determine other purchasable items associated with the upcoming events in step 202.

At 214, the cognitive event-related promotion generation program 110A, 110B generates promotions for the customer on the purchasable items and respective inventories. According to one embodiment, the cognitive event-related promotion generation program 110A, 110B may generate promotion as a single promotion or a set of promotions (i.e. different promotions for different items). Moreover, the generated promotions may include any type of promotions such as quantity-based promotions (e.g. buy-one-get-one-free), price discount promotions (e.g. 10% off sales prices), reward-based promotions (e.g. get $1 for every $10 spent), etc. Further, the generated promotions may be for a limited duration (e.g. promotions end when upcoming events end) or for one-time use only. The cognitive event-related promotion generation program 110A, 110B may generate promotions on the respective inventories so that a customer may come back and make additional purchases later.

At 216, the cognitive event-related promotion generation program 110A, 110B transmits the promotions to the customer highlighting the upcoming event. According to one embodiment, the cognitive event-related promotion generation program 110A, 110B may transmits the promotions to the customer highlighting key information related to products necessities for the upcoming events. According to one other embodiment, the cognitive event-related promotion generation program 110A, 110B may send the promotions via emails, SMS or social posts. In one other embodiment, the cognitive event-related promotion generation program 110A, 110B may post advertisements on the customer's social media sites. In another embodiment, the cognitive event-related promotion generation program 110A, 110B may display the promotions on a graphical user interface of a mobile application or on a seller website. The cognitive event-related promotion generation program 110A, 110B may highlight the need of the promoted products in the promotions in messages so that a customer does not forget the upcoming events and the reasons why the customer needs to purchase certain items. For example, the cognitive event-related promotion generation program 110A, 110B may send a promotional message, such as “Enjoy your upcoming golf trip on November 15th with XYZ lenses on your ABC DSRL camera! We offer a 10% discount only for you if you purchase the XYZ lenses now!”.

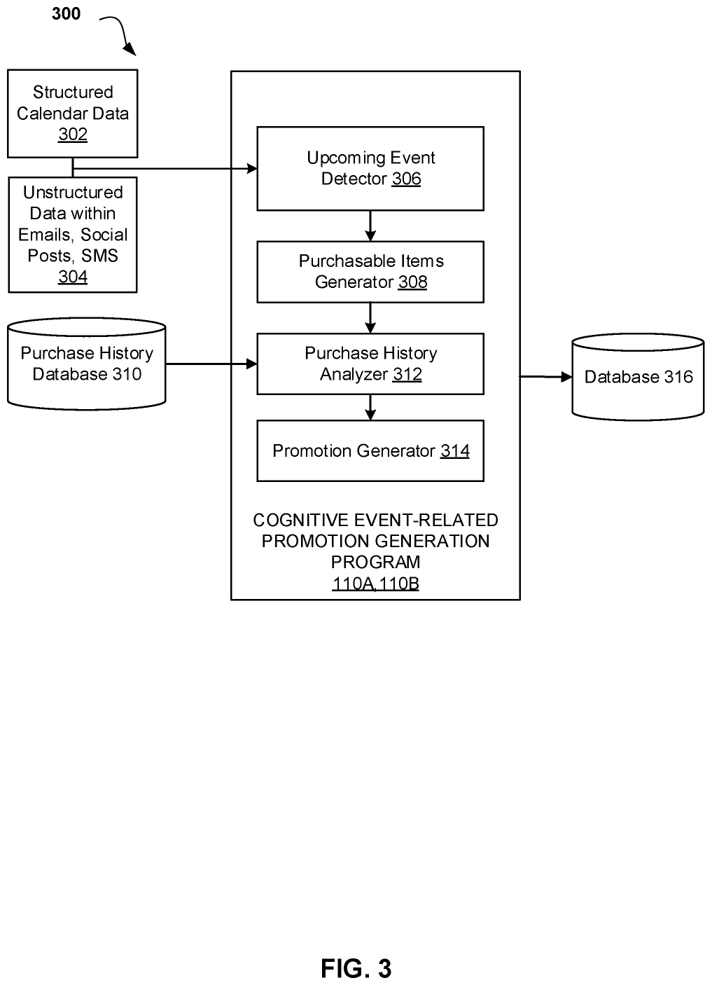

Referring now to FIG. 3, a functional block diagram of a cognitive event-related promotion generation process 300 is depicted according to at least one embodiment. According to one embodiment, the cognitive event-related promotion generation program 110A, 110B may consist of an upcoming event detector 306, a purchasable items generator 308, a purchase history analyzer 312, and a promotion generator 314. The upcoming event detector 306 may receive structured calendar data 302 and unstructured data 304 within emails, social posts and SMS and detect upcoming events. The purchasable items generator 308 may then determine purchasable items associated with the upcoming event based on data received from databases containing information related to product descriptions and recommendations. The purchasable items generator 308 may also determine purchasable items associated with the upcoming events based on a customer's previous purchasing activities or interests extracted from the structured data 302 and the unstructured data 304. The purchase history analyzer 312 may retrieve a customer's historic purchase data from a plurality of databases and determine whether promotions need to be generated based on the customer's purchase history and the quantity or amount of the items still remaining at the customer's business or home. The promotion generator 314 may generate promotions on the items which the cognitive event-related promotion generation program 110A, 110B determines that a customer needs to purchase based on a comparison between the purchase history and the determined purchasable items. The cognitive event-related promotion generation program 110A, 110B may save the analyzed purchase history and the generated promotions in a plurality of external databases for future references.

It may be appreciated that FIGS. 2-3 provide only an illustration of one implementation and do not imply any limitations with regard to how different embodiments may be implemented. Many modifications to the depicted environments may be made based on design and implementation requirements. For example, in at least one embodiment, the cognitive event-related promotion generation program 110A, 110B may utilize any sales channels, such as a physical store, web store or call center, etc. For example, a customer's location may be used to know if the customer entered the store utilizing GPS technologies, and the cognitive event-related promotion generation program 110A, 110B may determine when to send the generated promotions to the customer. In another embodiment, the cognitive event-related promotion generation program 110A, 110B may display the generated promotions to a customer service representative while a customer talks to the customer service representative. The cognitive event-related promotion generation program 110A, 110B may generate promotions not only on products but also on services. (e.g. massage, taxi, dentist, etc).

FIG. 4 is a block diagram 400 of internal and external components of the client computing device 102 and the server 112 depicted in FIG. 1 in accordance with an embodiment of the present invention. It should be appreciated that FIG. 4 provides only an illustration of one implementation and does not imply any limitations with regard to the environments in which different embodiments may be implemented. Many modifications to the depicted environments may be made based on design and implementation requirements.

The data processing system 402, 404 is representative of any electronic device capable of executing machine-readable program instructions. The data processing system 402, 404 may be representative of a smart phone, a computer system, PDA, or other electronic devices. Examples of computing systems, environments, and/or configurations that may represented by the data processing system 402, 404 include, but are not limited to, personal computer systems, server computer systems, thin clients, thick clients, hand-held or laptop devices, multiprocessor systems, microprocessor-based systems, network PCs, minicomputer systems, and distributed cloud computing environments that include any of the above systems or devices.

The client computing device 102 and the server 112 may include respective sets of internal components 402 a,b and external components 404 a,b illustrated in FIG. 4. Each of the sets of internal components 402 include one or more processors 420, one or more computer-readable RAMs 422, and one or more computer-readable ROMs 424 on one or more buses 426, and one or more operating systems 428 and one or more computer-readable tangible storage devices 430. The one or more operating systems 428, the software program 108 and the cognitive event-related promotion generation program 110A in the client computing device 102 and the cognitive event-related promotion generation program 110B in the server 112 are stored on one or more of the respective computer-readable tangible storage devices 430 for execution by one or more of the respective processors 420 via one or more of the respective RAMs 422 (which typically include cache memory). In the embodiment illustrated in FIG. 4, each of the computer-readable tangible storage devices 430 is a magnetic disk storage device of an internal hard drive. Alternatively, each of the computer-readable tangible storage devices 430 is a semiconductor storage device such as ROM 424, EPROM, flash memory or any other computer-readable tangible storage device that can store a computer program and digital information.

Each set of internal components 402 a,b also includes an R/W drive or interface 432 to read from and write to one or more portable computer-readable tangible storage devices 438 such as a CD-ROM, DVD, memory stick, magnetic tape, magnetic disk, optical disk or semiconductor storage device. A software program, such as the cognitive event-related promotion generation program 110A, 110B can be stored on one or more of the respective portable computer-readable tangible storage devices 438, read via the respective R/W drive or interface 432 and loaded into the respective hard drive 430.

Each set of internal components 402 a,b also includes network adapters or interfaces 436 such as a TCP/IP adapter cards, wireless Wi-Fi interface cards, or 3G or 4G wireless interface cards or other wired or wireless communication links. The software program 108 and the cognitive event-related promotion generation program 110A in the client computing device 102 and the cognitive event-related promotion generation program 110B in the server 112 can be downloaded to the client computing device 102 and the server 112 from an external computer via a network (for example, the Internet, a local area network or other, wide area network) and respective network adapters or interfaces 436. From the network adapters or interfaces 436, the software program 108 and the cognitive event-related promotion generation program 110A in the client computing device 102 and the cognitive event-related promotion generation program 110B in the server 112 are loaded into the respective hard drive 430. The network may comprise copper wires, optical fibers, wireless transmission, routers, firewalls, switches, gateway computers and/or edge servers.

Each of the sets of external components 404 a,b can include a computer display monitor 444, a keyboard 442, and a computer mouse 434. External components 404 a,b can also include touch screens, virtual keyboards, touch pads, pointing devices, and other human interface devices. Each of the sets of internal components 402 a,b also includes device drivers 440 to interface to computer display monitor 444, keyboard 442, and computer mouse 434. The device drivers 440, R/W drive or interface 432, and network adapter or interface 436 comprise hardware and software (stored in storage device 430 and/or ROM 424).

It is understood in advance that although this disclosure includes a detailed description on cloud computing, implementation of the teachings recited herein is not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is a service oriented with a focus on statelessness, low coupling, modularity, and semantic interoperability. At the heart of cloud computing is an infrastructure comprising a network of interconnected nodes.

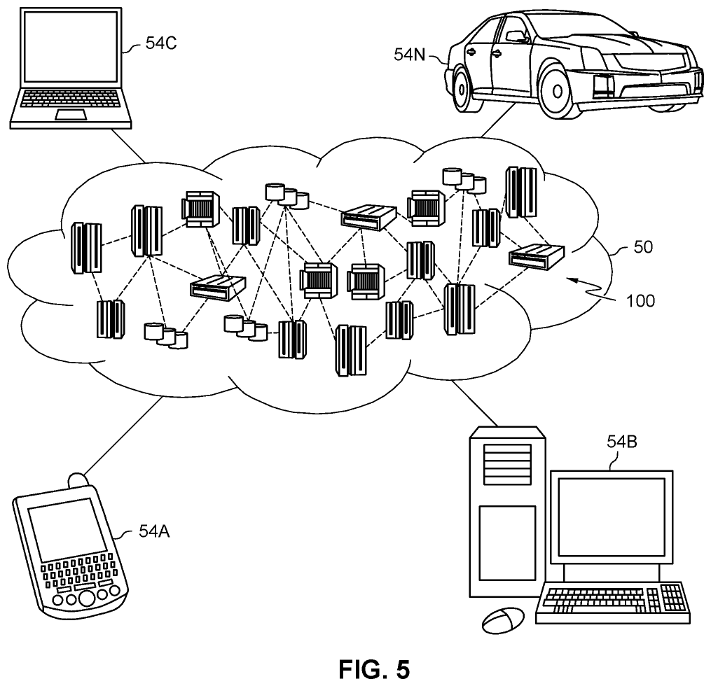

Referring now to FIG. 5, illustrative cloud computing environment 50 is depicted. As shown, cloud computing environment 50 comprises one or more cloud computing nodes 100 with which local computing devices used by cloud consumers, such as, for example, personal digital assistant (PDA) or cellular telephone 54A, desktop computer 54B, laptop computer 54C, and/or automobile computer system 54N may communicate. Nodes 100 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 5 are intended to be illustrative only and that computing nodes 100 and cloud computing environment 50 can communicate with any type of computerized device over any type of network and/or network addressable connection (e.g., using a web browser).

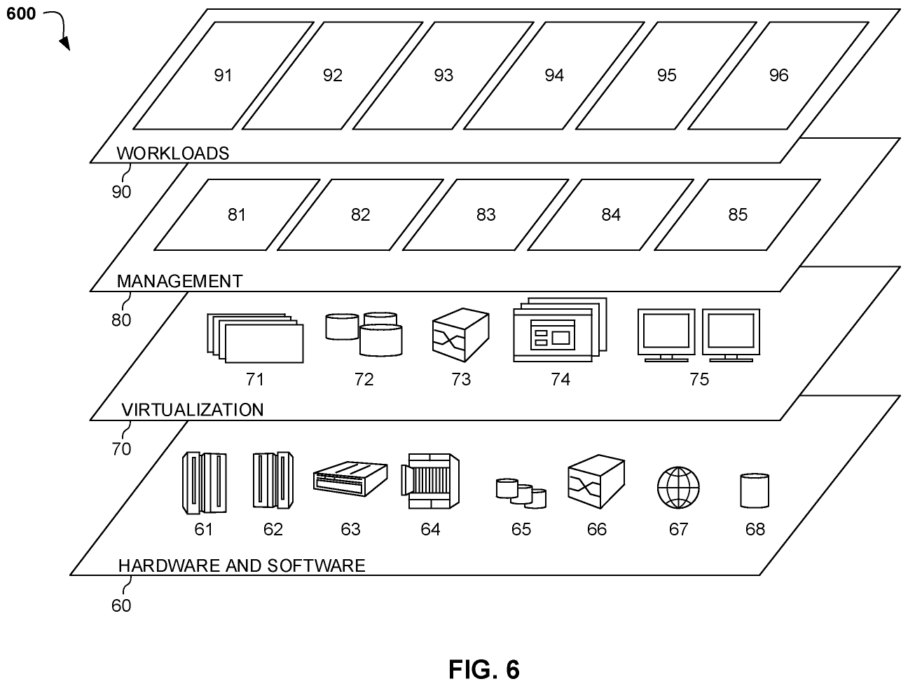

Referring now to FIG. 6, a set of functional abstraction layers 600 provided by cloud computing environment 50 is shown. It should be understood in advance that the components, layers, and functions shown in FIG. 7 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and cognitive event-related promotion generation 96. Cognitive event-related promotion generation 96 may relate to generating promotions on various products or services based on a customer's data related to upcoming events, monitoring a database of a customer's historic purchases which may provide information as to what products or services need to be purchased again.

The descriptions of the various embodiments of the present invention have been presented for purposes of illustration but are not intended to be exhaustive or limited to the embodiments disclosed. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A processor-implemented method for cognitive event-related promotion generation, the method comprising:
receiving, by a processor, a plurality of data related to an individual's upcoming events;
identifying an upcoming event based on the plurality of received data;
extracting event parameters from the plurality of received data utilizing natural language processing technologies;
determining purchasable products associated with the identified upcoming events and the extracted event parameters;
collecting a plurality of purchase history data associated with the individual;
determining a product within the determined purchasable products was purchased in the past by the individual based on the determined plurality of purchase history data associated with the individual;
determining the purchased product is unconsumable, expired, or obsolete based on a duration of ownership of the purchased product that exceeds a pre-configured ownership threshold established by manufacture data or product descriptions in a product database;
determining whether the purchased product is unconsumable, expired or obsolete satisfying the pre-configured threshold conditions;
in response to determining that the purchased product is unconsumable, expired, or obsolete, generating a targeted promotion for the individual on the determined purchasable products; and
transmitting the generated promotion to the individual highlighting key information related to product necessities for the upcoming events.

2. The method of claim 1, further comprising:
determining purchasable services associated with the identified upcoming events and the extracted event parameters.

3. The method of claim 1, wherein the event parameters are selected from a group consisting of a start date, a start time, an end date, an end time, venues, participants, and event duration and an event theme.

4. The method of claim 1, wherein determining whether the products purchased in the past are unconsumable, expired or obsolete is manually preconfigured by the individual.

5. The method of claim 1, wherein the generated promotion is a single promotion or a set of promotions for different products for one or more upcoming events.

6. The method of claim 1, wherein the generated promotion is either one-time use only or expires after a pre-configured period of time.

7. The method of claim 1, wherein the transmission of the generated promotions to the individual is selected from a group consisting of emails, SMS, social posts, displayed on a graphical user interface of a mobile application or on a seller website.

8. A computer system for cognitive event-related promotion generation, the computer system comprising:
receiving, by a processor, a plurality of data related to an individual's upcoming events;
identifying an upcoming event based on the plurality of received data;
extracting event parameters from the plurality of received data utilizing natural language processing technologies;
determining purchasable products associated with the identified upcoming events and the extracted event parameters;
collecting a plurality of purchase history data associated with the individual;
determining a product within the determined purchasable products was purchased in the past by the individual based on the determined plurality of purchase history data associated with the individual;
determining the purchased product is unconsumable, expired, or obsolete based on a duration of ownership of the purchased product that exceeds a pre-configured ownership threshold established by manufacture data or product descriptions in a product database;
determining whether the purchased product is unconsumable, expired or obsolete satisfying the pre-configured threshold conditions;
in response to determining that the purchased product is unconsumable, expired, or obsolete, generating a targeted promotion for the individual on the determined purchasable products; and
transmitting the generated promotion to the individual highlighting key information related to product necessities for the upcoming events.

9. The computer system of claim 8, further comprising:
determining purchasable services associated with the identified upcoming events and the extracted event parameters.

10. The computer system of claim 8, wherein the event parameters are selected from a group consisting of a start date, a start time, an end date, an end time, venues, participants, and event duration and an event theme.

11. The computer system of claim 8, wherein determining whether the products purchased in the past are unconsumable, expired or obsolete is manually preconfigured by the individual.

12. The computer system of claim 8, wherein the generated promotion is a single promotion or a set of promotions for different products for one or more upcoming events.

13. The computer system of claim 8, wherein the generated promotion is either one-time use only or expires after a pre-configured period of time.

14. The computer system of claim 8, wherein the transmission of the generated promotions to the individual is selected from a group consisting of emails, SMS, social posts, displayed on a graphical user interface of a mobile application or on a seller website.

15. A computer program product for cognitive event-related promotion generation, the computer program product comprising:
receiving, by a processor, a plurality of data related to an individual's upcoming events;
identifying an upcoming event based on the plurality of received data;
extracting event parameters from the plurality of received data utilizing natural language processing technologies;
determining purchasable products associated with the identified upcoming events and the extracted event parameters;
collecting a plurality of purchase history data associated with the individual;
determining a product within the determined purchasable products was purchased in the past by the individual based on the determined plurality of purchase history data associated with the individual;
determining the purchased product is unconsumable, expired, or obsolete based on a duration of ownership of the purchased product that exceeds a pre-configured ownership threshold established by manufacture data or product descriptions in a product database;
determining whether the purchased product is unconsumable, expired or obsolete satisfying the pre-configured threshold conditions;
in response to determining that the purchased product is unconsumable, expired, or obsolete, generating a targeted promotion for the individual on the determined purchasable products; and
transmitting the generated promotion to the individual highlighting key information related to product necessities for the upcoming events.

16. The computer program product of claim 15, further comprising:
determining purchasable services associated with the identified upcoming events and the extracted event parameters.

17. The computer program product of claim 15, wherein the event parameters are selected from a group consisting of a start date, a start time, an end date, an end time, venues, participants, and event duration and an event theme.

18. The computer program product of claim 15, wherein determining whether the products purchased in the past are unconsumable, expired or obsolete is manually preconfigured by the individual.

19. The computer program product of claim 15, wherein the generated promotion is a single promotion or a set of promotions for different products for one or more upcoming events.

20. The computer program product of claim 15, wherein the generated promotion is either one-time use only or expires after a pre-configured period of time.
